(19) United States
(12) Patent Application Publication
(10) Pub. No.: US 2012/0276366 A1
(43) Pub. Date: Nov. 1, 2012

(54) FLEXIBLE SLATE VENEER ARCHITECTURAL PANEL

(76) Inventors: Eric Toupin, Chestermere (CA); Terry Sommerfeldt-Bain, Calgary (CA)

(21) Appl. No.: 13/096,108

(22) Filed: Apr. 28, 2011

(51) Int. Cl. B32B 3/26

(52) U.S. Cl. 428/314.4

(57) ABSTRACT

A flexible slate veneer architectural panel includes a slate veneer and a flexible closed cell foam backing The panel exhibits high flexibility permitting the panel to be attached to curved building structures with an adhesive or with mechanical fasteners if desired. The panel further provides an interface between the building surface to which it is attached and the slate veneer that is capable of absorbing different thermal expansions and contractions of the slate veneer and the building surface thereby preventing delamination of the panel from the building surface and preventing cracking of the slate veneer.

### FIELD OF THE INVENTION

The present invention relates generally to stone veneer, and more particularly, relating to a flexible slate veneer architectural panel.

### BACKGROUND OF THE INVENTION

Natural slate veneer is a popular material for architectural uses because of its light weight which permits its use in both vertical and horizontal applications without consideration of load bearing issues, its flexibility which permits attachment to curved surface, is available in various colors and textures, and provides an atheistically pleasing appearance of natural stone at a lower cost. Natural slate veneer is comprised of a thin sheet of slate with a thin reinforcing backing layer that is typically comprised of a polymer composite that my include reinforcing fibers such as fiberglass.

While natural slate veneer is a popular and versatile construction material it does has several drawbacks. Initially, due to the nature of its construction that enables its flexibility, the back surface of the veneer comprises the natural texture of the slate sheet which results in gaps between the veneer and the surface to which the veneer is attached. This is undesirable because it results in less surface contact between the veneer and the attachment surface. Additionally, while the thin construction of the veneer lends to its flexibility and lower weight, the thin construction does not lend itself to a three-dimensional look that is attained by natural stone blocks. Further, the use of the veneer is limited in cold climates because it tends to delaminate from the attachment surface due to the difference in the thermal expansion properties of the veneer and the attachment surface.

### SUMMARY OF THE INVENTION

The embodiments of the present invention provided a flexible slate veneer architectural panel that overcomes the drawbacks of existing slate veneer while retaining all of the benefits of slate veneer.

Embodiments of the present invention also provide a flexible slate veneer panel architectural having a three-dimensional appearance.

Embodiments of the present invention further provide a flexible slate veneer architectural panel that may be used in cold weather climates.

Embodiments of the present invention further provide a flexible slate veneer architectural panel that adds to the insulation value of the structure to which the panel is attached.

Embodiments of the present invention further provide a flexible slate veneer architectural panel that is easily manufactured, reliable and cost-effective.

Embodiments of the present invention further provide a flexible slate veneer architectural panel that is secured to a structure without the use of mechanical fasteners.

To achieve these and other advantages, in general, in one aspect, flexible slate veneer architectural panel includes a sheet of slate veneer having a front surface and a back surface. A flexible sheet of closed cell foam is substantially adhered to the entire area of said back surface of said sheet of slate veneer, wherein the panel exhibits the same flexibility of said sheet of slate veneer prior to attachment to said flexible sheet of closed cell foam.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a perspective view of a flexible slate veneer architectural panel constructed in accordance with the principles of the present invention;

FIG. 2 is an enlarged cross-section view of the panel taken along line 2-2 of FIG. 1,

FIG. 3 is a diagrammatic assembly view of the panel according to a process of the present invention;

FIG. 4 is a perspective view of a flexible slate veneer architectural panel in accordance with the principles of the present invention attached to a building structure;

FIG. 5 is a cross-sectional view of the construction of FIG. 4 taken along line 5-5 of FIG. 4; and

FIG. 6 is a perspective view of a flexible slate veneer architectural panel in accordance with the principles of the present invention having an alternative construction.

### DETAILED DESCRIPTION OF THE INVENTION

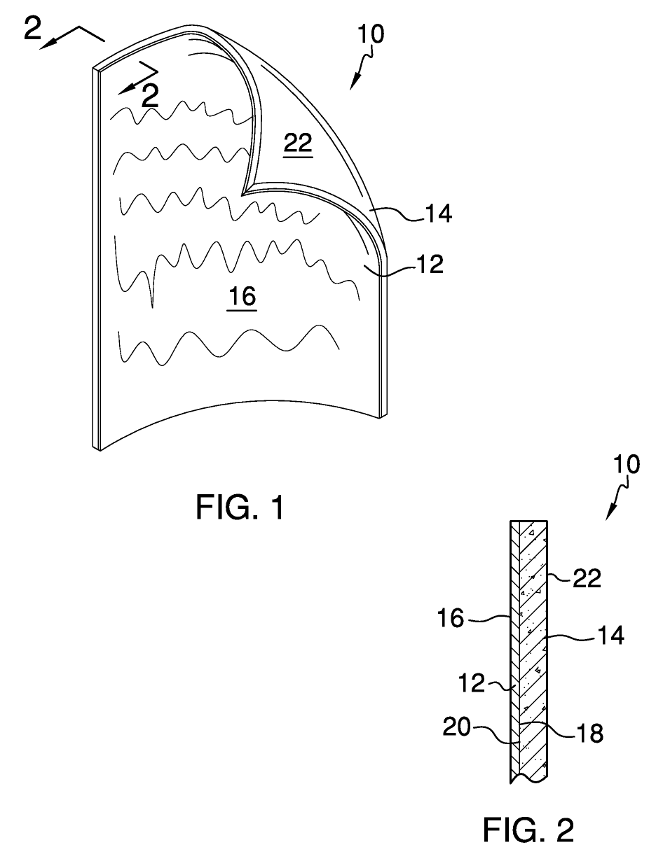

Referring now to FIGS. 1 and 2, there is shown a flexible slate veneer architectural panel embodying the principles of the invention and generally designated by reference number 10. Panel 10 comprises a flexible slate veneer sheet 12 adhered to a flexible supportive backing 14. The slate veneer sheet 12 has a total thickness of between about 1 mm and about 5 mm and has a front face 16 comprising natural slate and a back face 18 comprising a cured polymer resin and optionally a cured polymer resin with fiber reinforcement, such a fiberglass. The flexible supportive backing 14 has a total thickness of between about 1.58 mm and about 76.00 mm and has a front face 20 and a back face 22. The flexible support backing 14 is comprised of a closed cell, expanded polyethylene foam material. In an exemplary embodiment, the foam material is Nor-Cell XLPE bun type, closed cell, cross linked, expanded polyethylene foam free of chlorofluorocarbon and hydrochlorofluorocarbons.

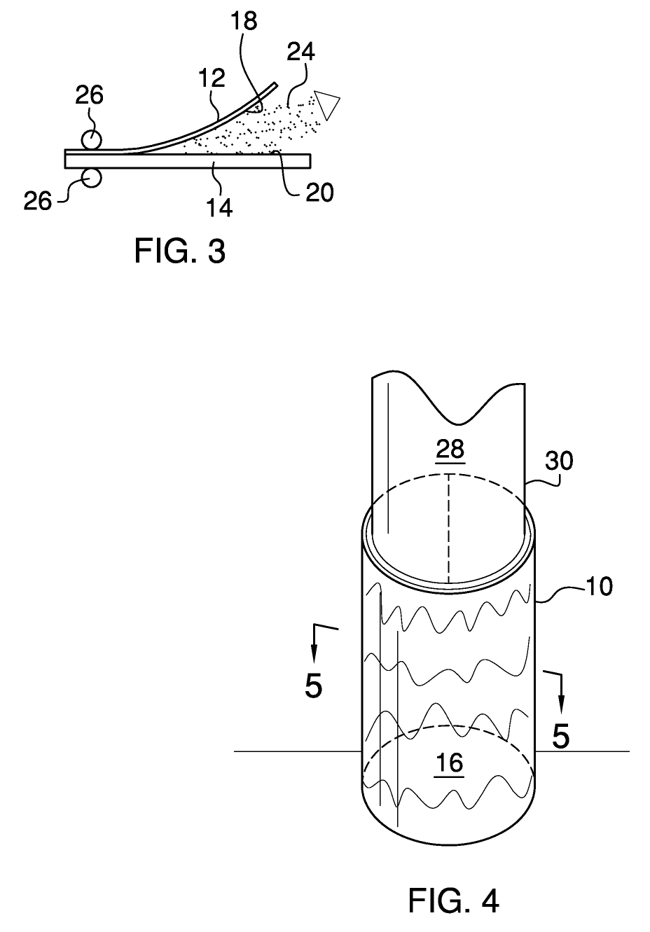

Turning to FIG. 3, panel 10 is constructed by supplying a suitably dimensioned flexible slate veneer sheet 12 and a suitably dimensioned sheet of flexible supportive backing 14. The slate veneer sheet 12 is secured to the flexible supportive backing 14 by a applying suitable adhesive by spraying, rolling or brushing the adhesive 24 onto the back face 18 of the slate veneer sheet 12, the front face 20 of the backing 14 or both, and then pressing the slate veneer sheet and the backing together, for example by nip rollers 26, such that substantially the entire area of the back face of the slate veneer sheet is adhered to the front face of the backing with minimal to no voids between the contact surfaces.

The assembled panel 10 exhibits substantially the same flexibility of the slate veneer sheet 12 prior to the sheet being adhered to the backing 14. Further, the panel 10 comprises a substantially smooth back surface 22 for attachment to a building surface. Additionally, the backing 14 insulates the building surface to which the panel 10 is secured and increased the R-value of the building structure. Further yet, a critical aspect of the panel 10 is the backing 14 provides an interface surface between the slate veneer sheet 12 and the building surface that is capable of absorbing the different thermal expansions of the slate veneer sheet and the building surface, thereby preventing the panel 10 from delaminating from the building surface and additionally preventing cracking of the slate veneer sheet.

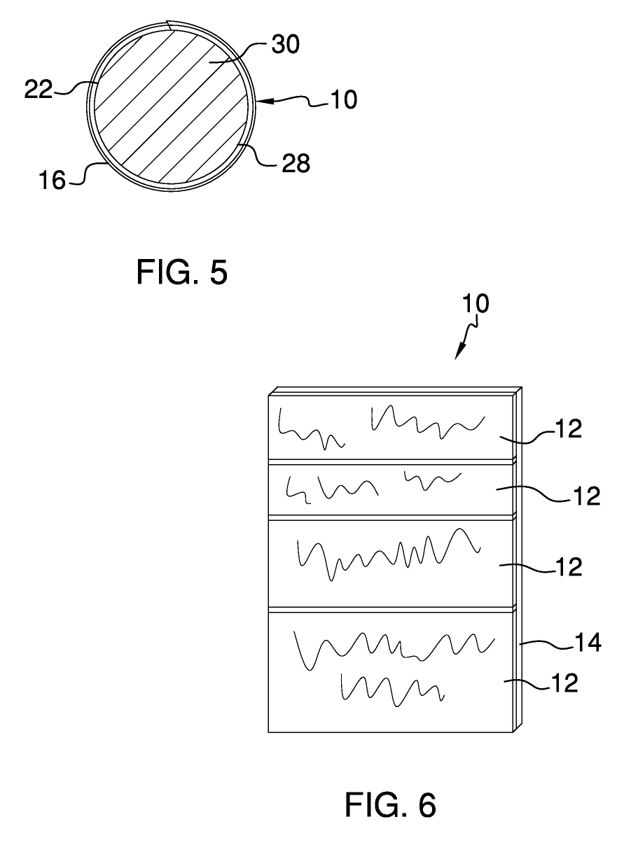

In FIGS. 4 and 5, a panel 10 is shown attached to a building surface 28 of a column structure 30. The panel 10 is attached to the building surface 28 using conventional construction adhesives with the back face 22 in contact with the building surface and with the front, slate face, 16 facing outwardly from the building surface.

Turning to FIG. 6, there is illustrated a panel 10 which exemplifies the versatility in which the panel may be fabricated. As illustrated here, panel 10 includes a series of separate slate veneer sheets 12 arranged in a spaced pattern on backing 14 providing an aesthetically pleasing look to the panel. Endless patterns may be created by arranging slate veneer sheets as desired on backing 14.

A number of embodiments of the present invention have been described. Nevertheless, it will be understood that various modifications may be made without departing from the spirit and scope of the invention. Accordingly, other embodiments are within the scope of the following claims.

What is claimed is:

1. A flexible slate veneer architectural panel, comprising:
a sheet of slate veener having a closed cell foam backing.

2. The panel of claim 1, wherein said sheet of slate veneer is about 2 mm in thickness.

3. The panel of claim 1, wherein said sheet of closed cell foam material is about 3.2 mm in thickness.

4. A flexible slate veneer architectural panel, comprising:
a sheet of slate veneer having a front surface and a back surface;
a flexible sheet of closed cell foam substantially adhered to the entire area of said back surface of said sheet of slate veneer; and
wherein said panel exhibits the same flexibility of said sheet of slate veneer prior to attachment to said flexible sheet of closed cell foam.

5. The flexible laminated slate panel of claim 4, wherein said sheet of slate veneer is a thickness of between about 1 mm and about 5 mm.

6. The flexible laminated slate panel of claim 4, wherein said sheet of closed cell foam material is thickness of between about 1.58 mm and 76 mm.
